(19) United States
(12) Patent Application Publication
(10) Pub. No.: US 2019/0039112 A1
(43) Pub. Date: Feb. 7, 2019

(54) PRESSING DEVICE AND PRESSING METHOD FOR METAL PLATE

(71) Applicant: TOYOTA BOSHOKU KABUSHIKI KAISHA, Aichi-ken (JP)

(72) Inventors: Kazuyuki HIRATA, Toyota-shi (JP); Harutaka ODA, Toyota-shi (JP)

(73) Assignee: TOYOTA BOSHOKU KABUSHIKI KAISHA, Aichi-ken (JP)

(21) Appl. No.: 16/041,294

(22) Filed: Jul. 20, 2018

(30) Foreign Application Priority Data
Aug. 4, 2017 (JP) 2017-151572

(51) Int. Cl. B21D 28/26; H01M 2/14

(52) U.S. Cl. CPC B21D 28/26; H01M 2/145

(57) ABSTRACT

A pressing device for a metal plate includes a support frame configured to support an outer edge of a metal plate that extends horizontally, a lower die, and an upper die. The support frame includes a tray that supports the outer edge of the metal plate by mounting the metal plate on the tray and a positioning member that positions the metal plate, which is mounted on the tray, relative to the tray. The upper die includes a frame-shaped pushing member that moves integrally with the upper die and holds the outer edge of the metal plate between the pushing member and the tray of the support frame when the upper die and the lower die are clamped.

### BACKGROUND OF THE INVENTION

The present invention relates to a pressing device and a pressing method for a metal plate.

Pressing a metal plate includes deforming a metal plate in conformance with the shape of a workpiece that is to be formed, punching the workpiece out of the metal plate, and the like. The pressing is performed, for example, in the following manner so that the metal plate can be easily carried and pressed. Japanese Laid-Open Patent Publication No. 2015-178123 describes a pressing device in which the outer edge of a metal plate extending horizontally is supported by a support frame. The support frame is carried to a space between an upper die and a lower die that are open and then arranged on the lower die. In this state, the upper die is downwardly moved toward the lower die so that they are clamped. This presses the metal plate, which has the outer edge supported by the support frame.

FIG. 9A shows the vertical cross section of the support frame supporting the outer edge of the metal plate. FIG. 9B shows a state in which the support frame is viewed from above. The support frame 81 includes a lower frame body 83 and an upper frame body 84, which vertically hold the outer edge of a metal plate 82. The lower frame body 83 and the upper frame body 84 are coupled to each other by multiple bolts 85. The bolts 85 are arranged along the support frame 81, i.e., along the outer edge of the metal plate 82. Fastening of the bolts 85 pulls the lower frame body 83 and the upper frame body 84 toward each other with force (axial force) acting in the axial direction of the bolts 85. This holds the outer edge of the metal plate 82.

The holding of the outer edge of the metal plate 82 between the lower frame body 83 and the upper frame body 84 of the support frame 81 limits accidental deformation of the metal plate 82 when the metal plate 82 is carried and pressed. Thus, the metal plate 82 can be easily carried and pressed.

### SUMMARY OF THE INVENTION

The lower frame body 83 and the upper frame body 84 of the support frame 81 hold the outer edge of the metal plate 82 by pulling the lower frame body 83 and the upper frame body 84 toward each other with the axial force of the bolts 85. Thus, multiple through holes through which the bolts 85 are inserted need to be arranged in the outer edge of the metal plate 82. Accordingly, in order for the area of a contact surface of the outer edge with the lower frame body 83 and the upper frame body 84 to become enough to hold the outer edge, the portion of the outer edge of the metal plate 82 held between the lower frame body 83 and the upper frame body 84 needs to be enlarged. However, the enlargement of the portion of the outer edge of the metal plate 82 held between the lower frame body 83 and the upper frame body 84 increases the amount of the metal plate 82 required to manufacture the workpiece. This reduces the yield when manufacturing the workpiece from the metal plate 82.

It is an object of the present invention to provide a pressing device and a pressing method for a metal plate that limit reduction in the yield when manufacturing workpieces from metal plates.

A pressing device for a metal plate that solves the above problem includes a support frame configured to support an outer edge of a metal plate that extends horizontally, a lower die, and an upper die. The pressing device presses the metal plate by arranging the support frame on the lower die of the lower die and the upper die that are open in a state in which the support frame supports the outer edge of the metal plate and by downwardly moving the upper die toward the lower die in the state so that the upper die and the lower die are clamped. The support frame includes a tray that supports the outer edge of the metal plate by mounting the metal plate on the tray and a positioning member that positions the metal plate, which is mounted on the tray, relative to the tray. The upper die includes a frame-shaped pushing member that moves integrally with the upper die and holds the outer edge of the metal plate between the pushing member and the tray of the support frame when the die clamping is performed.

In a method for pressing a metal plate that solves the above problem, the metal plate is pressed by carrying the metal plate, which extends horizontally, to a space between a lower die and an upper die and then downwardly moving the upper die toward the lower die so that the lower die and the upper die are clamped. The method includes preparing the lower die, the upper die, and a support frame that includes a tray and a positioning member. The upper die includes a frame-shaped pushing member that moves integrally with the upper die. The method further includes supporting an outer edge of the metal plate with the tray and positioning the metal plate relative to the support frame with the positioning member by mounting the metal plate on the support frame, carrying the metal plate, which has the outer edge supported by the tray, to the space between the lower die and the upper die by moving the support frame toward the space between the lower die and the upper die that are open so that the support frame is arranged on the lower die, and holding the outer edge of the metal plate between the pushing member and the tray of the support frame when performing the die clamping.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram showing the entirety of a forming device, which is a pressing device that performs a forming process;

FIG. 2 is a diagram showing how the forming device of FIG. 1 works;

FIG. 3 is a plan view showing a support frame and a metal plate after the forming process is performed;

FIG. 4 is a cross-sectional view taken along line A-A in FIG. 3;

FIG. 5 is a cross-sectional view taken along line B-B in FIG. 3;

FIG. 6 is a diagram showing the entirety of a punching device, which is a pressing device that performs a punching process;

FIG. 7 is a diagram showing how the punching device of FIG. 6 works;

FIG. 8 is a diagram showing how the punching device of FIG. 6 works;

FIG. 9A is a vertical cross-sectional view showing a conventional support frame that supports the outer edge of the metal plate; and

FIG. 9B is a plan view showing the conventional support frame of FIG. 9A.

### DETAILED DESCRIPTION OF THE PREFERRED EMBODIMENTS

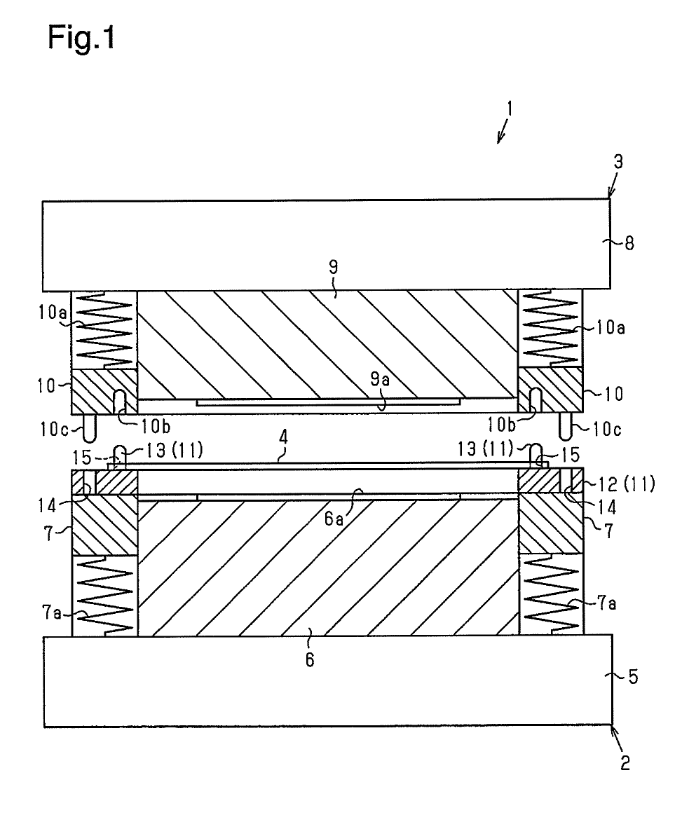

A pressing device and a pressing method for a metal plate according to one embodiment will now be described with reference to FIGS. 1 to 8.

Pressing a metal plate includes deforming a metal plate in conformance with the shape of a workpiece that is to be formed, punching the workpiece out of the metal plate, and the like. In the present embodiment, a separator arranged in a cell stack of a fuel cell is manufactured as a workpiece by pressing a metal plate. In the method for pressing the metal plate, a forming process for deforming a forming region of the metal plate in conformance with the shape of the workpiece (separator) is first performed. Then, a punching process for punching the workpiece out of the forming region of the metal plate is performed. The workpiece (separator) is manufactured by sequentially performing the forming process and the punching process.

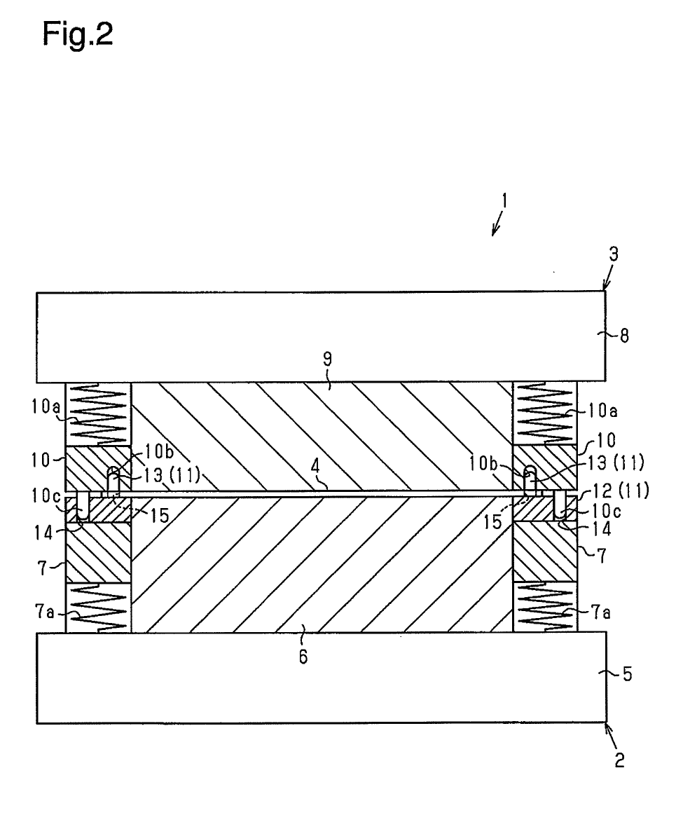

FIGS. 1 and 2 show a forming device 1 that performs the forming process in the method for pressing the metal plate. The forming device 1 functions as the pressing device for the metal plate to implement the forming process. As shown in FIG. 1, the forming device 1 includes a fixed lower die 2 and a movable upper die 3. The upper die 3 is located above the lower die 2 and vertically moves toward or away from the lower die 2. The lower die 2 of the forming device 1 includes a lower base 5, a lower forming portion 6, and a stripper 7. The lower base 5 is fixed to the installation surface of the forming device 1. The lower forming portion 6 is fixed to the upper surface of the lower base 5 so as to project upward. The stripper 7 surrounds the lower forming portion 6 and is vertically movable relative to the lower base 5. Further, the lower base 5 includes springs 7a that support the stripper 7 so that the upper end of the stripper 7 is located upward from the upper end of the lower forming portion 6.

A rectangular support frame 11, on which a metal plate 4 is mounted, is carried to a space between the lower die 2 and the upper die 3 that are open. The metal plate 4 has a rectangular shape extending horizontally. The support frame 11 includes a tray 12 that supports the outer edge of the metal plate 4 and multiple pins 13 that project upward from the tray 12 and extend through the outer edge of the metal plate 4. The pins 13 function as positioning members that position the metal plate 4 mounted on the tray 12 relative to the tray 12. The support frame 11 is mounted on the stripper 7 of the lower die 2 and includes multiple through holes 14. The through holes 14 are used to position the support frame 11 relative to the lower die 2 and the upper die 3.

The upper die 3 of the forming device 1 includes an upper base 8, an upper forming portion 9, and a pushing member 10. The upper base 8 is vertically moved by a lift. The upper forming portion 9 is fixed to the lower surface of the upper base 8 and opposed to the lower forming portion 6 of the lower die 2. The pushing member 10 surrounds the upper forming portion 9 and is vertically movable relative to the lower base 5. Further, the upper base 8 includes springs 10a that support the pushing member 10 so that the lower end of the pushing member 10 is located downward from the lower end of the upper forming portion 9. The pushing member 10 is located in correspondence with the stripper 7 of the lower die 2 and frame-shaped in the same manner as the stripper 7. The pushing member 10 includes multiple recesses 10b and multiple pins 10c in the lower surface. The recesses 10b accommodate the distal ends of the pins 13 of the support frame 11 arranged on the stripper 7. The pins 10c can be inserted into the through holes 14 of the support frame 11. Further, the upper forming portion 9 of the upper die 3 includes an upper forming surface 9a, and the lower forming portion 6 of the lower die 2 includes a lower forming surface 9b. The upper forming surface 9a and the lower forming surface 9b are opposed to each other. In the forming process, the portion (forming region) of the metal plate 4 located inward from the support frame 11 is deformed in conformance with the shape of the workpiece (separator) by the upper forming surface 9a and the lower forming surface 9b.

In the forming device 1, the support frame 11 supporting the outer edge of the metal plate 4 with the tray 12 is carried to the space between the lower die 2 and the upper die 3 that are open. Downward movement of the upper die 3 with the support frame 11 located on the stripper 7 of the lower die 2 causes the lower die 2 and the upper die 3 of the forming device 1 to be clamped. The outer edge of the metal plate 4 is held between the pushing member 10 moving integrally with the upper die 3 and the tray 12 of the support frame 11 arranged on the stripper 7 of the lower die 2.

In addition, insertion of the pins 10c of the pushing member 10 into the through holes 14 of the support frame 11 positions the support frame 11 relative to the stripper 7 and the pushing member 10. That is, the metal plate 4 is positioned relative to the lower die 2 and the upper die 3. Further, the distal ends of the pins 13 of the support frame 11 are accommodated in the recesses 10b formed in the lower surface of the pushing member 10.

When the upper die 3 is further moved downward with the outer edge of the metal plate 4 held between the pushing member 10 and the tray 12 of the support frame 11, the forming region of the metal plate 4 (portion located inward from support frame 11) is held between the lower forming portion 6 and the upper forming portion 9 as shown in FIG. 2 while compressing the springs 7a and 10a. This deforms the forming region of the metal plate 4 in conformance with the shape of the workpiece (separator).

Subsequently, upward movement of the upper die 3 from the clamped state causes the lower die 2 and the upper die 3 of the forming device 1 to be opened. When the die opening is performed in such a manner, the upper forming portion 9 of the upper die 3 moves away from the lower forming portion 6 of the lower die 2 and the pushing member 10 of the upper die 3 moves away from the outer edge of the metal plate 4. As a result, the support frame 11 on which the metal plate 4 is mounted can be removed from the stripper 7 of the lower die 2 and can be carried so as to perform the punching process in the method for pressing the metal plate.

The support frame 11 and the metal plate 4 will now be described in detail.

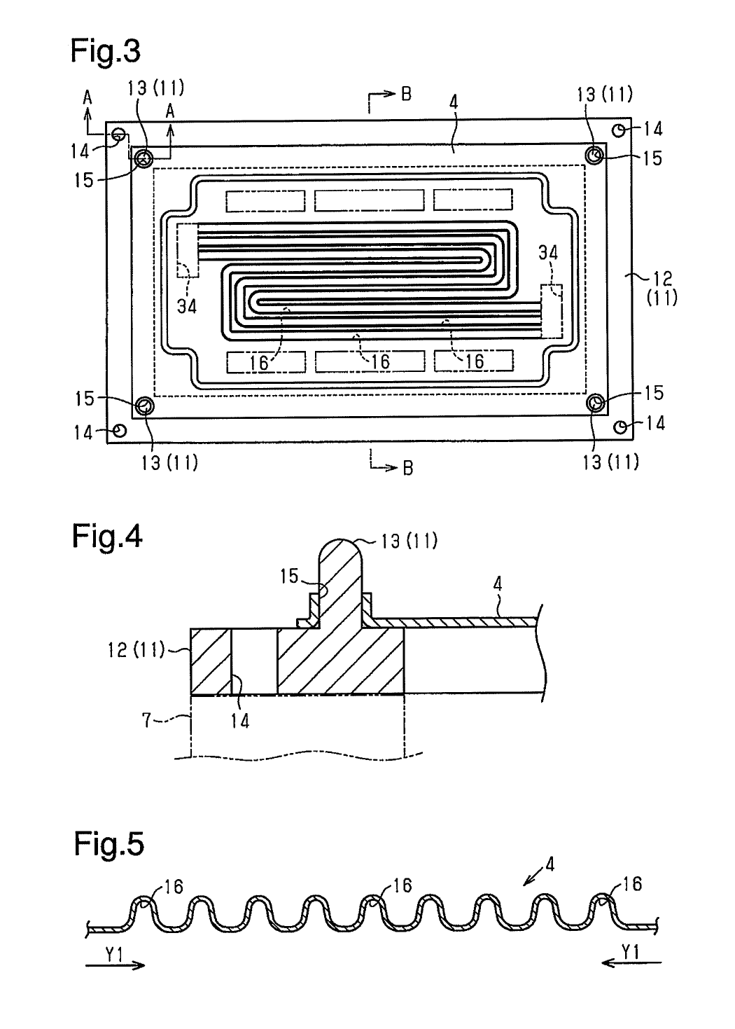

FIG. 3 shows the support frame 11 removed from the forming device 1 of FIG. 1 that has undergone the forming process. In the support frame 11, the through holes 14 through which the pins 10c of the pushing member 10 of the upper die 3 are inserted are formed at four corners of the support frame 11. Further, the upper surface of the support frame 11 defines the tray 12 supporting the outer edge of the metal plate 4. The pins 13 of the support frame 11 are located inward from the through holes 14 at the four corners of the support frame 11.

As shown in FIGS. 3 and 4, through holes 15, through which the pins 13 of the support frame 11 are inserted, are formed through burring at four corners of the outer edge of the metal plate 4. That is, the through holes 15 are formed by forming through holes that are smaller in size than the pins 13 at the four corners of the outer edge of the metal plate 4 and then inserting the pins 13 into the through holes to deform the surroundings of the through holes. The thus formed through holes 15 limits removal of the pins 13 inserted into the through holes 15 from the through holes 15. This further ensures the positioning of the metal plate 4 relative to the support frame 11.

Multiple passage grooves 16 are formed in the forming region of the metal plate 4 through the forming process. The passage grooves 16 form passages in a cell stack of a fuel cell. Fluid such as fuel gas, oxidation gas, and coolant flow through the passages. As shown in FIG. 5, the passage grooves 16 are formed by curving the metal plate 4 through the forming process. Thus, when the passage grooves 16 are formed, curving of the metal plate 4 causes the forming region to shrink in a widthwise direction of the passage grooves 16. Accordingly, the outer edge of the metal plate 4 is pulled in the direction of arrow Y1 in FIG. 5.

The action of force on the outer edge of the metal plate 4 in the direction of arrow Y1 is canceled by opening the lower die 2 and the upper die 3 of the forming device 1 in the forming process. This is because the die opening cancels holding of the outer edge of the metal plate 4 by the pushing member 10 of the upper die 3 and the tray 12 of the support frame 11 and thereby permits movement of the outer edge of the metal plate 4 that is caused by the force acting in the direction of arrow Y1. Movement of the outer edge of the metal plate 4 is permitted because the metal plate 4 is positioned relative to the support frame 11 at the four corners by the pins 13 and the through holes 15.

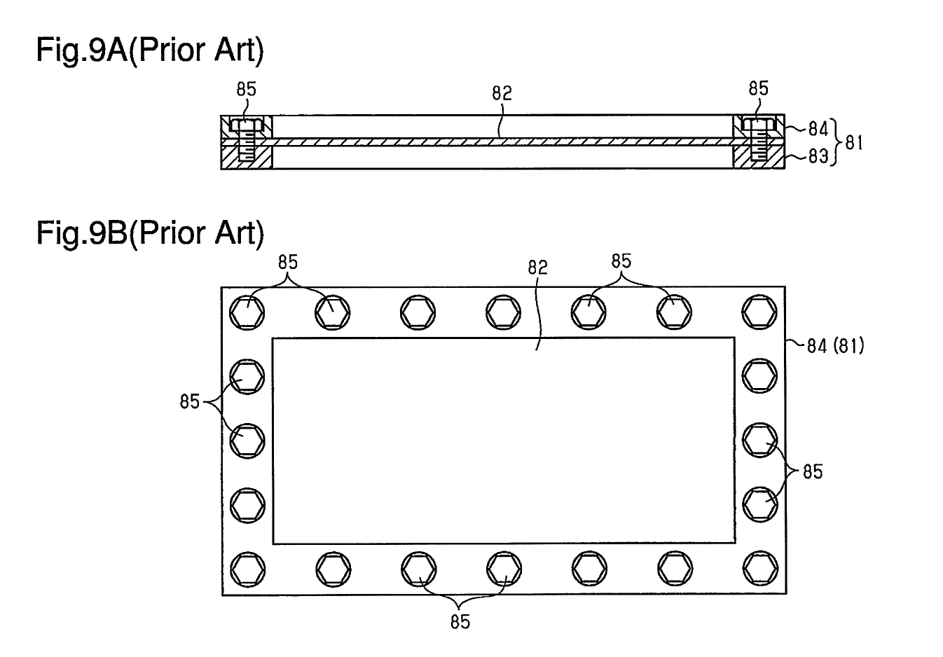

If the outer edge of the metal plate 4 is always held like in a conventional support frame of FIGS. 9A and 9B, the force acting in the direction of arrow Y1 remains applied to the outer edge of the metal plate 4 even after the die opening of the forming device 1 is performed. Thus, the punching process is performed in a state in which the force remains applied to the outer edge of the metal plate 4. As a result, when the workpiece (separator) is punched out of the forming region of the metal plate 4 in the punching process, the action of the force on the outer edge of the metal plate 4 is canceled suddenly. Such a sudden cancellation of the action of the force on the outer edge of the metal plate 4 may adversely affect punching of the workpiece out of the metal plate 4 and, for example, warp the punched workpiece. The occurrence of such a problem is limited by positioning the four corners of the metal plate 4 relative to the support frame 11 by the pins 13 and the through holes 15 as described above.

The punching device that performs the punching process in the method for pressing the metal plate will now be described.

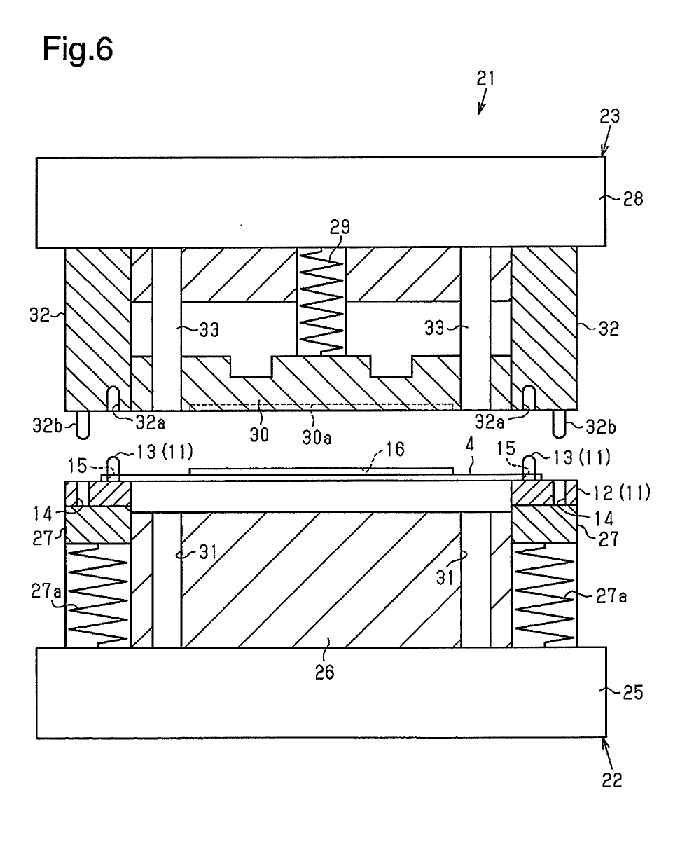

FIGS. 6 to 8 show the punching device and how the punching device works. The punching device functions as the pressing device for the metal plate to implement the punching process. As shown in FIG. 6, a punching device 21 includes a fixed lower die 22 and a movable upper die 23. The upper die 23 is located above the lower die 22 and vertically moves toward or away from the lower die 22. The lower die 22 of the punching device 21 includes a lower base 25, a fixed portion 26, and a stripper 27. The lower base 25 is fixed to the installation surface of the punching device 21. The fixed portion 26 is fixed to the upper surface of the lower base 25 so as to project upward. The stripper 27 surrounds the fixed portion 26 and is vertically movable relative to the lower base 25. Further, the lower base 25 includes springs 27a that support the stripper 27. Multiple punched holes 31 are formed in the fixed portion 26.

The rectangular support frame 11 on which the metal plate 4 that has undergone the forming process is mounted is carried to the space between the lower die 22 and the upper die 23 that are open. The support frame 11 is mounted on the stripper 27 of the lower die 22.

The upper die 23 of the punching device 21 includes an upper base 28, a pushing portion 30, a punch 32, and multiple hole forming members 33. The upper base 28 is vertically moved by a lift. The pushing portion 30 is located downward from the upper base 28 and connected to the upper base 28 by a spring 29. The punch 32 is frame-shaped so as to surround the pushing portion 30 and fixed to the lower surface of the upper base 28. Each hole forming member 33 is bar-shaped and fixed to the lower surface of the upper base 28 to extend through the pushing portion 30. The pushing portion 30 is located in correspondence with the forming region of the metal plate 4 on the support frame 11 that is arranged on the stripper 27 of the lower die 22. Further, the pushing portion 30 has a rectangular shape in correspondence with the workpiece (separator) punched out of the forming region of the metal plate 4. Additionally, the lower surface of the pushing portion 30 includes multiple recesses 30a that accommodate portions of the forming region of the metal plate 4 corresponding to the passage grooves 16.

The punch 32 is used to punch the separator out of the forming region of the metal plate 4 on the support frame 11 that is arranged on the stripper 27 of the lower die 22. The punch 32 is opposed to the stripper 27. The punch 32 includes multiple recesses 32a and multiple pins 32b in the lower surface. The recesses 32a accommodate the distal ends of the pins 13 of the support frame 11 arranged on the stripper 7. The pins 32b can be inserted into the through holes 14 of the support frame 11.

The hole forming members 33 are opposed to the punched holes 31 of the fixed portion 26 of the lower die 22. The hole forming members 33 form multiple passage holes 34 in the separator punched out of the forming region of the metal plate 4 as shown by the double-dashed lines in FIG. 3. The passage holes 34 are used as passages through which fluids such as fuel gas, oxidation gas, and coolant flow to a cell stack of a fuel cell.

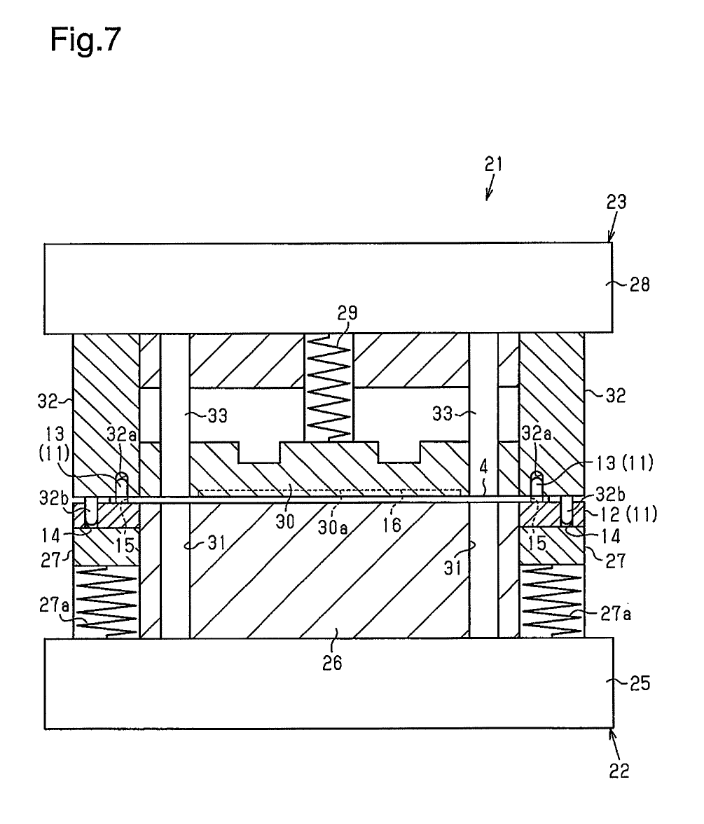

In the punching device 21, the support frame 11 supporting the outer edge of the metal plate 4 with the tray 12 is carried to a space between the lower die 22 and the upper die 23 that are open. Downward movement of the upper die 23 with the support frame 11 located on the stripper 27 of the lower die 22 clamps the lower die 22 and the upper die 23 of the punching device 21. As shown in FIG. 7, the outer edge of the metal plate 4 is held between the punch 32 that has moved integrally with the upper die 23 and the tray 12 of the support frame 11 arranged on the stripper 27 of the lower die 22.

In addition, insertion of the pins 32b into the through holes 14 of the support frame 11 positions the support frame 11 relative to the stripper 27 and the punch 32. That is, the metal plate 4 is positioned relative to the lower die 22 and the upper die 23. Further, the distal ends of the pins 13 of the support frame 11 are accommodated in the recesses 32a formed in the lower surface of the punch 32.

In this manner, the punch 32 functions as a pushing member that holds the outer edge of the metal plate 4 between the punch 32 and the tray 12 when the die clamping is performed. Further, the lower surface of the pushing portion 30 and the lower surfaces of the hole forming members 33 strike the forming region of the metal plate 4, and the portions corresponding to the passage grooves 16 in the forming region of the metal plate 4 are accommodated in the recesses 30a formed in the lower surface of the pushing portion 30.

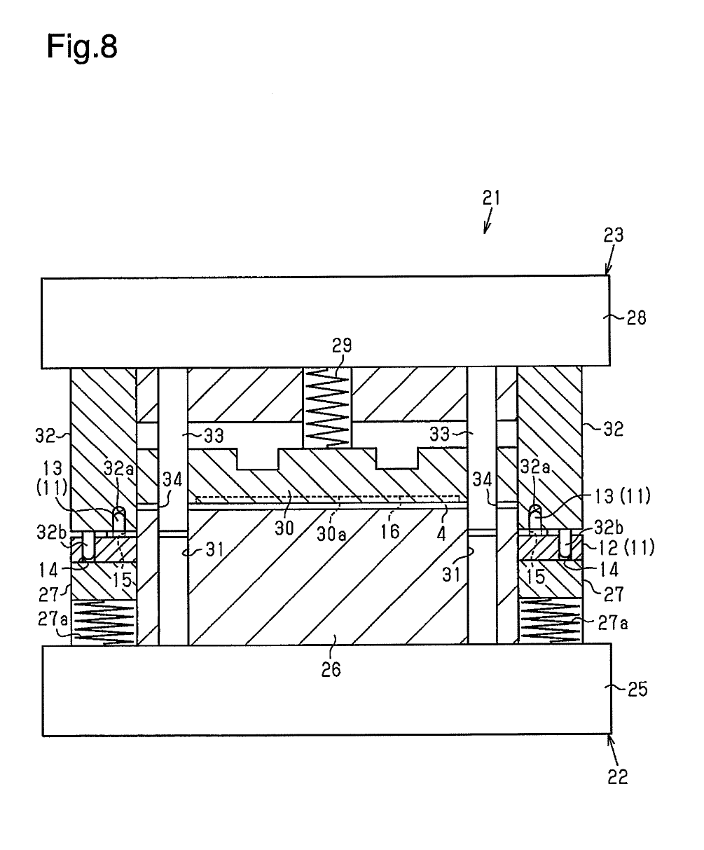

As described above, when the upper die 23 is further moved downward with the outer edge of the metal plate 4 held between the punch 32 and the tray 12 of the support frame 11, the punch 32 pushes down the outer edge of the metal plate 4 as shown in FIG. 8 while compressing the springs 27a. This punches the workpiece (separator) out of the forming region of the metal plate 4 between the fixed portion 26 and the punch 32. In addition, the hole forming members 33 punch portions of the forming region of the metal plate 4 that correspond to the punched holes 31, thereby forming the passage holes 34 in the separator (refer to FIG. 3).

Subsequently, when the upper die 23 is moved upward from the clamped state, the lower die 22 and the upper die 23 of the punching device 21 are opened. When the lower die 22 and the upper die 23 are opened in such a manner, the punch 32 of the upper die 23 moves away from the outer edge of the metal plate 4 and the pushing portion 30 of the upper die 23 downwardly ejects the workpiece (separator) sticking to the upper die 23 with the force of the spring 29. Afterwards, the separator is carried from the space between the lower die 22 and the upper die 23, the outer edge of the metal plate 4 remaining on the support frame 11 on the stripper 27 of the lower die 22 is removed, and the support frame 11 is removed from the stripper 27.

As described above, the present embodiment has the following advantages.

(1) When the workpiece (separator) is manufactured from the metal plate 4, the metal plate 4 is carried with the support frame 11 mounted on the metal plate 4. The outer edge of the metal plate 4 is supported by the tray 12 of the support frame 11, and the metal plate 4 is positioned relative to the support frame 11 by the pins 13 and the through holes 15.

In the forming process, the support frame 11 on which the metal plate 4 is mounted is carried to the space between the lower die 2 and the upper die 3 of the forming device 1 that are open and then arranged on the stripper 7 of the lower die 2. In this state, when the upper die 3 is moved downward to perform the clamping, the pushing member 10 moves integrally with the upper die 3 and holds the outer edge of the metal plate 4 between the pushing member 10 and the tray 12 of the support frame 11. The outer edge of the metal plate 4 is held between the pushing member 10 and the tray 12 of the support frame 11. In this state, pressing is performed to deform the forming region of the metal plate 4 by clamping the lower die 2 and the upper die 3.

Further, in the punching process subsequent to the forming process, the support frame 11 on which the metal plate 4 having the deformed forming region is mounted is carried to the space between the lower die 22 and the upper die 23 of the punching device 21 that are open and then arranged on the stripper 27 of the lower die 22. In this state, when the upper die 23 is moved downward to clamp the lower die 22 and the upper die 23, the punch 32 moves integrally with the upper die 23 and holds the outer edge of the metal plate 4 between the punch 32 and the tray 12 of the support frame 11. The outer edge of the metal plate 4 is held between the punch 32 and the tray 12 of the support frame 11. In this state, pressing is performed to punch the workpiece (separator) out of the forming region of the metal plate 4 in conformance with the shape of the workpiece (separator) by clamping the lower die 22 and the upper die 23.

In the forming device 1 and the punching device 21, the pressing is performed with the outer edge of the metal plate 4 held between the pushing member (pushing member 10 or punch 32) and the tray 12 of the support frame 11. This eliminates the need for the outer edge of the metal plate 4 to include through holes or the like through which bolts are inserted in order to hold the outer edge like in the prior art. Thus, the portion of the outer edge of the metal plate 4 held between the tray 12 and the pushing member (portion other than forming region) does not need to be enlarged so that the area of a contact surface of the outer edge of the metal plate 4 with the tray 12 and the pushing member becomes enough to hold the outer edge. Accordingly, the increase in the amount of the metal plate 4 required for manufacturing the workpiece (separator) caused by the enlargement of the portion of the outer edge of the metal plate 4 held between the tray 12 and the pushing member is limited, thereby limiting reduction in the yield when manufacturing the workpiece from the metal plate 4.

(2) In the conventional support frame, when the metal plate is coupled to or removed from the support frame, multiple bolts connecting the lower frame body and the upper frame body need to be fastened or loosened. This takes a tremendous amount of time and trouble. In the support frame 11 of the present embodiment, the metal plate 4 is mounted on the tray 12, and the metal plate 4 is positioned relative to the support frame 11 by the pins 13 and the through holes 15. This facilitates the coupling of the metal plate 4 to the support frame 11 and the removal of the metal plate 4 from the support frame 11. Further, in the support frame 11, the outer edge of the metal plate 4 can be held between the tray 12 and the pushing member (pushing member 10 or punch 32) when performing the pressing. This allows the pressing to be performed stably.

(3) In the punching device 21 that performs the punching process, when the upper die 23 is moved downward to perform the die clamping, the punch 32 functioning as the pushing member holds the outer edge of the metal plate 4 between the punch 32 and the tray 12 of the support frame 11 and the workpiece (separator) is punched out of the forming region of the metal plate 4 between the fixed portion 26 of the lower die 22 and the punch 32. Since the punch 32 functions as the pushing member, as shown by the broken lines in FIG. 3, the section of the metal plate 4 cut by punching the workpiece out of the metal plate 4 between the punch 32 and the fixed portion 26 is located proximate to the inner edge of the support frame 11. This minimizes the portions of the metal plate 4 other than where the workpiece is formed. Accordingly, the reduction in the yield when manufacturing the workpiece from the metal plate 4 is limited further effectively.

(4) In the forming device 1 that performs the forming process, the formation of the passage grooves 16 in the forming region of the metal plate 4 causes the forming region of the metal plate 4 to shrink in the widthwise direction of the passage grooves 16. Thus, the outer edge of the metal plate 4 is pulled in the shrinking direction. Such action of force on the outer edge of the metal plate 4 is canceled through the die opening of the forming device 1. This is because the metal plate 4 is positioned relative to the support frame 11 by the pins 13 and the through holes 15 at the four corners and movement of the outer edge of the metal plate 4 resulting from the action of the force is permitted when the holding of the outer edge of the metal plate 4 between the pushing member 10 of the upper die 3 and the tray 12 of the support frame 11 is canceled by performing the die opening. This restricts situations in which the action of the force on the outer edge of the metal plate 4 is canceled suddenly when the punching process is performed by the punching device 21 in a state in which the force remains applied to the metal plate 4 to punch the workpiece (separator) out of the forming region of the metal plate 4. This limits situations in which the sudden cancellation of the action of the force on the outer edge of the metal plate 4 resulting from the punching of the workpiece adversely affects the punching of the workpiece out of the metal plate 4 and, for example, warps the workpiece after punching.

It should be apparent to those skilled in the art that the present invention may be embodied in many other specific forms without departing from the spirit or scope of the invention. Particularly, it should be understood that the present invention may be embodied in the following forms.

The workpiece manufactured from the metal plate 4 does not have to be a separator arranged in a cell stack of a fuel cell.

The pins 13 may be arranged at portions other than the four corners of the support frame 11. In this case, the through holes 15 of the metal plate 4 are formed at positions corresponding to the pins 13 of the support frame 11.

The through holes 15 may be arranged at portions other than the four corners of the support frame 11. In this case, the pins 10c of the pushing member 10 of the forming device 1 and the pins 32b of the punch 32 of the punching device 21 are formed at positions corresponding to the through holes 15 of the support frame 11.

Therefore, the present examples and embodiments are to be considered as illustrative and not restrictive and the invention is not to be limited to the details given herein, but may be modified within the scope and equivalence of the appended claims.

1. A pressing device for a metal plate, the pressing device comprising:
a support frame configured to support an outer edge of a metal plate that extends horizontally;
a lower die; and
an upper die, wherein
the pressing device presses the metal plate by arranging the support frame on the lower die of the lower die and the upper die that are open in a state in which the support frame supports the outer edge of the metal plate and by downwardly moving the upper die toward the lower die in the state so that the upper die and the lower die are clamped,
the support frame includes a tray that supports the outer edge of the metal plate by mounting the metal plate on the tray and a positioning member that positions the metal plate, which is mounted on the tray, relative to the tray, and
the upper die includes a frame-shaped pushing member that moves integrally with the upper die and holds the outer edge of the metal plate between the pushing member and the tray of the support frame when the die clamping is performed.

2. The pressing device according to claim 1, wherein
the lower die includes a fixed portion that holds the metal plate between the fixed portion and the upper die when the die clamping is performed,
the upper die includes a punch that punches a workpiece out of the metal plate when the die clamping is performed, and
the punch functions as the pushing member and is frame-shaped to hold the outer edge of the metal plate between the punch and the tray of the support frame when the die clamping is performed.

3. The pressing device according to claim 1, wherein
the lower die includes a lower forming surface,
the upper die includes an upper forming surface,
the lower forming surface and the upper forming surface are opposed to each other and are configured to deform the metal plate in conformance with a shape of a workpiece that is to be formed by holding the metal plate when the die clamping is performed, and
the pushing member surrounds the upper forming surface.

4. The pressing device according to claim 2, wherein the workpiece is a separator arranged in a cell stack of a fuel cell.

5. The pressing device according to claim 3, wherein the workpiece is a separator arranged in a cell stack of a fuel cell.

6. A method for pressing a metal plate by carrying the metal plate, which extends horizontally, to a space between a lower die and an upper die and then downwardly moving the upper die toward the lower die so that the lower die and the upper die are clamped, the method comprising:
preparing the lower die, the upper die, and a support frame that includes a tray and a positioning member, wherein the upper die includes a frame-shaped pushing member that moves integrally with the upper die;
supporting an outer edge of the metal plate with the tray and positioning the metal plate relative to the support frame with the positioning member by mounting the metal plate on the support frame;
carrying the metal plate, which has the outer edge supported by the tray, to the space between the lower die and the upper die by moving the support frame toward the space between the lower die and the upper die that are open so that the support frame is arranged on the lower die; and
holding the outer edge of the metal plate between the pushing member and the tray of the support frame when performing the die clamping.

7. The method according to claim 6, wherein
the lower die includes a fixed portion that holds the metal plate between the fixed portion and the upper die when the die clamping is performed,
the upper die includes a punch that punches a workpiece out of the metal plate when the die clamping is performed, and
the punch functions as the pushing member and is frame-shaped to hold the outer edge of the metal plate between the punch and the tray of the support frame when the die clamping is performed.

8. The method according to claim 6, wherein
the lower die includes a lower forming surface,
the upper die includes an upper forming surface,
the lower forming surface and the upper forming surface are opposed to each other and are configured to deform the metal plate in conformance with a shape of a workpiece that is to be formed by holding the metal plate when the die clamping is performed, and
the pushing member surrounds the upper forming surface.

9. The method according to claim 7, wherein the workpiece is a separator arranged in a cell stack of a fuel cell.

10. The method according to claim 8, wherein the workpiece is a separator arranged in a cell stack of a fuel cell.
